(19) United States
(12) Patent Application Publication
(10) Pub. No.: US 2024/0318712 A1
(43) Pub. Date: Sep. 26, 2024

(54) ELECTRIC DRIVE UNIT

(71) Applicant: Schaeffler Technologies AG & Co. KG, Herzogenaurach (DE)

(72) Inventors: Steven Wilson, JR., Wellington, OH (US); Patrick Lindemann, Wooster, OH (US)

(73) Assignee: Schaeffler Technologies AG & Co. KG, Herzogenaurach (DE)

(21) Appl. No.: 18/545,411

(22) Filed: Dec. 19, 2023

Related U.S. Application Data
(60) Provisional application No. 63/453,652, filed on Mar. 21, 2023.

(51) Int. Cl. F16H 57/021; B60K 1/00; B60K 17/04; F16H 57/04; H02K 1/30; H02K 5/15; H02K 7/08; H02K 7/116; H02K 9/197

(52) U.S. Cl. CPC F16H 57/021; B60K 1/00; B60K 17/04; F16H 57/0457; F16H 57/0471; H02K 1/30; H02K 5/15; H02K 7/085; H02K 7/116; H02K 9/197; B60K 2001/001; F16H 2057/02034; F16H 2057/02052

(57) ABSTRACT

An electric drive unit includes a housing, rotor shaft, motor, and plurality of bearings. The housing defines motor housing and gearbox regions. The housing has a bearing shield extending between the motor housing and gearbox regions and defining an aperture. The rotor shaft extends through the aperture from the motor housing region into the gearbox region. The motor is within the motor housing region and includes a stator and a rotor on the rotor shaft. The plurality of bearings are coupled with, and support and facilitate rotation of, the rotor shaft. The plurality of bearings includes every bearing of the electric drive unit that is coupled with, and configured to support and facilitate rotation of, the rotor shaft. At least one of (1) each of the plurality of bearings is outside of the motor housing region and (2) each of the plurality of bearings is within the gearbox region.

### CROSS-REFERENCE TO RELATED APPLICATIONS

This application claims the benefit of priority under 35 U.S.C. § 119 of U.S. Provisional Application No. 63/453,652, filed on Mar. 21, 2023, the entire contents of which are incorporated herein by reference.

### FIELD OF THE DISCLOSURE

The present disclosure generally relates to an electric drive unit. More specifically, the present disclosure relates to an electric axle assembly that includes a rotor shaft supported by a plurality of bearings disposed within a gearbox region of the electric axle assembly.

### BACKGROUND OF THE DISCLOSURE

In general, electric axles are structures used in motor vehicles. Electric axles include a number of components, including electric motors.

### SUMMARY OF THE DISCLOSURE

According to a first aspect of the present disclosure, an electric drive unit includes a housing, a rotor shaft, a motor, and a plurality of bearings. The housing defines a motor housing region and a gearbox region. The housing has a bearing shield that extends between the motor housing region and the gearbox region and defines an aperture. The rotor shaft extends axially through the aperture from the motor housing region into the gearbox region. The motor is disposed within the motor housing region and includes a stator and a rotor arranged on the rotor shaft. The plurality of bearings are operably coupled with the rotor shaft and are configured to support and facilitate rotation of the rotor shaft. The plurality of bearings includes every bearing of the electric drive unit that is operably coupled with the rotor shaft and configured to support and facilitate rotation of the rotor shaft. Further, at least one of (1) each of the plurality of bearings is disposed outside of the motor housing region and (2) each of the plurality of bearings is disposed within the gearbox region.

Embodiments of the first aspect of the disclosure can include any one or a combination of the following features:
the plurality of bearings comprises a first bearing that extends radially between the bearing shield and the rotor shaft;
the first bearing is an unsealed bearing;
the plurality of bearings further comprises a second bearing axially offset from the first bearing, such that the second bearing is further than the first bearing from the aperture defined by the bearing shield;
the rotor shaft is an assembly of a plurality of coaxial rotor shaft components;
each of the plurality of bearings is disposed outside of the motor housing region;
each of the plurality of bearings is disposed within the gearbox region; and
the electric drive unit is a portion of an electric axle assembly of a vehicle.

According to a second aspect of the present disclosure, an electric axle assembly for a vehicle includes a housing, a motor, a rotor shaft, and a plurality of bearings. The housing defines an interior region. The motor is disposed within the interior region and has a stator and a rotor that extends in a first axial direction from a first axial end to a second axial end opposite the first axial end and includes an axial midpoint positioned axially equidistant from the first and second axial ends of the rotor. The rotor shaft is operably coupled with the rotor, such that operation of the motor drives rotation of the rotor shaft. The plurality of bearings are operably coupled with the rotor shaft and configured to support and facilitate rotation of the rotor shaft. The plurality of bearings includes every bearing of the electric axle assembly that is operably coupled with the rotor shaft and configured to support and facilitate rotation of the rotor shaft. Further, each of the plurality of bearings is axially offset from the axial midpoint of the rotor in the first axial direction.

Embodiments of the second aspect of the disclosure can include any one or a combination of the following features:
at least a portion of each of the plurality of bearings is axially offset from the second axial end of the rotor in the first axial direction;
the interior region includes a motor housing region that houses the motor, and a gearbox region, and the rotor shaft extends from the motor housing region into the gearbox region;
each of the plurality of bearings is positioned within the gearbox region;
each of the plurality of bearings is positioned outside of the motor housing region;
a gearset disposed within the gearbox region and operable to splash fluid disposed within the gearbox region to lubricate at least one of the plurality of bearings;
the motor housing region and the gearbox region are sealed from each other, such that fluid is prevented from entering the motor housing region from the gearbox region; and
the rotor shaft is an assembly of a plurality of coaxial rotor shaft components.

According to a third aspect of the present disclosure, an electric axle assembly for a vehicle includes a housing, a motor, a spindle, a rotor shaft, and at least one bearing. The housing defines an interior region. The motor has a stator and a rotor and is disposed within the interior region defined by the housing. The motor is operable to drive rotation of a rotor carrier that defines a rotor carrier hollow and that is axially aligned with and radially inboard of the rotor. The spindle defines a spindle hollow. The spindle is coupled to the housing and extends within the rotor carrier hollow. The rotor shaft extends through the spindle hollow and is coupled to the rotor carrier, such that the rotor shaft and rotor carrier are configured to rotate together at a common rate of rotation. The at least one bearing extends radially between the rotor carrier and the spindle. The at least one bearing is configured to support and facilitate rotation of the rotor carrier relative to the spindle.

Embodiments of the third aspect of the disclosure can include any one or a combination of the following features:
the rotor extends axially from a first axial end of the rotor to a second axial end of the rotor opposite the first axial end, and the at least one bearing comprises a plurality of bearings that includes each bearing that supports and facilitates rotation of the rotor carrier, wherein at least a portion of each bearing of the plurality of bearings is positioned axially between the first axial end of the rotor and the second axial end of the rotor;
the rotor carrier and the spindle at least partially define a fluid flow passage for fluid that is configured to absorb heat from the motor that is transferred through the rotor carrier and lubricate the at least one bearing; and
the fluid flow passage is sealed, such that the fluid does not flow to the motor.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic view of a vehicle that includes an electric drive unit as part of an electric axle assembly of the vehicle, according to one embodiment;

FIG. 2 is a cross-sectional view of an electric drive unit that includes an electric motor that drives rotation of a rotor shaft that extends into a gearbox region of a housing of the electric drive unit and is supported by a plurality of bearings disposed within the gearbox region, according to one embodiment;

FIG. 3 is an enlarged view of area III of FIG. 2, illustrating the rotor shaft supported by the plurality of bearings disposed within the gearbox region defined by the housing, according to one embodiment;

FIG. 4 is a cross-sectional view of an electric drive unit, illustrating a motor disposed within a housing, a rotor carrier, a spindle, a rotor shaft, and a plurality of bearings disposed between the spindle and the rotor carrier, according to one embodiment; and

FIG. 5 is an enlarged view of area V of FIG. 4, illustrating the housing, motor, rotor carrier, spindle, rotor shaft, and bearings, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis of a shaft configured to rotate in operation of the apparatus described herein. The term “coaxial” shall be understood to refer to rotatable about a common axis. Further, the term “radial” and derivatives thereof, such as “radially,” shall be understood in relation to the axis of the aforementioned shaft. For example, “radially outboard” refers to further away from the axis, while “radially inboard” refers to nearer to the axis.

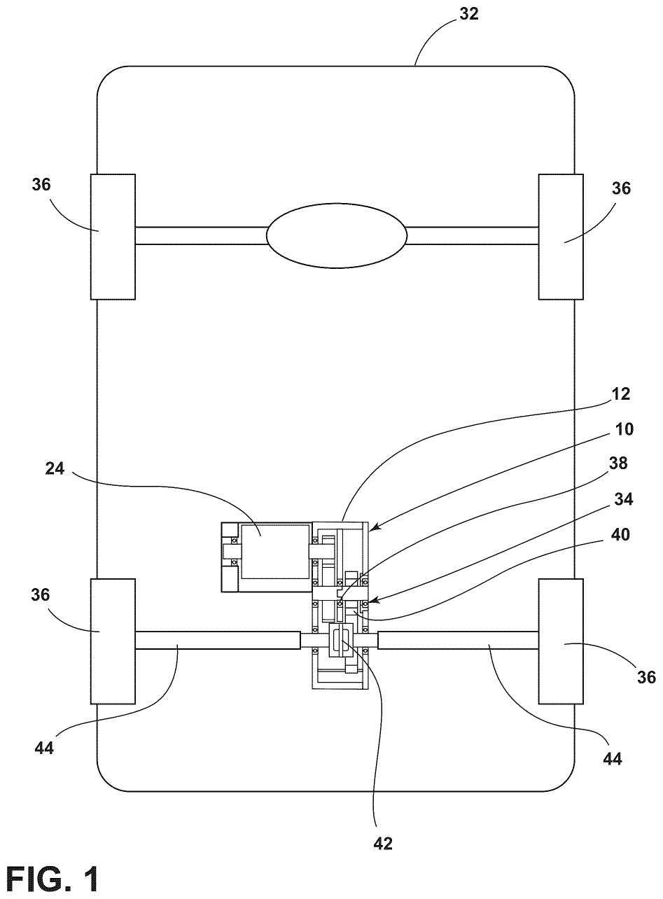

Referring now to FIGS. 1-5, an electric drive unit 10 includes a housing 12 that defines a motor housing region 14 and a gearbox region 16. The housing 12 includes a bearing shield 18 that extends between the motor housing region 14 and the gearbox region 16. The bearing shield 18 defines an aperture 20. A rotor shaft 22 extends axially through the aperture 20 from the motor housing region 14 into the gearbox region 16. A motor 24 is disposed within the motor housing region 14 and includes a stator 26 and a rotor 28 that is arranged on the rotor shaft 22. A plurality of bearings 30 are operably coupled with the rotor shaft 22. The plurality of bearings 30 are configured to support and facilitate rotation of the rotor shaft 22. The plurality of bearings 30 includes every bearing of the electric drive unit 10 that is operably coupled with the rotor shaft 22 and configured to support and facilitate rotation of the rotor shaft 22. Each of the plurality of bearings 30 is disposed outside the motor housing region 14, and/or each of the plurality of bearings 30 is disposed within the gearbox region 16.

Referring now to FIG. 1, a vehicle 32 is illustrated. The vehicle 32 may be an electric vehicle and/or a hybrid electric vehicle. In the embodiment illustrated in FIG. 1, the vehicle 32 includes the electric drive unit 10. As illustrated, the electric drive unit 10 is a portion of an electric axle assembly 34 of the vehicle 32. The electric drive unit 10 includes the electric motor 24 which includes the stator 26 and the rotor 28 and is configured to drive rotation of the rotor shaft 22, in various embodiments. The rotor shaft 22 may be operably coupled with at least one wheel 36 of the vehicle 32, such that rotation of the rotor shaft 22 drives rotation of the at least one wheel 36 in operation of the electric drive unit 10. In various implementations, the electric drive unit 10 of the vehicle 32 includes a transmission 38. The transmission 38 can include a gearset 40 and/or a differential 42. The gearset 40 may be configured to interface with the rotor shaft 22 and the differential 42, and the differential 42 may be configured to interface with half shafts 44 of the vehicle 32 that are coupled with wheels 36 of the vehicle 32. As such, rotation of the rotor shaft 22 by the electric motor 24 may drive rotation of the half shafts 44 and the attached wheels 36 of the vehicle 32 via the operable coupling of the half shafts 44 to the rotor shaft 22 by the gearset 40 and the differential 42.

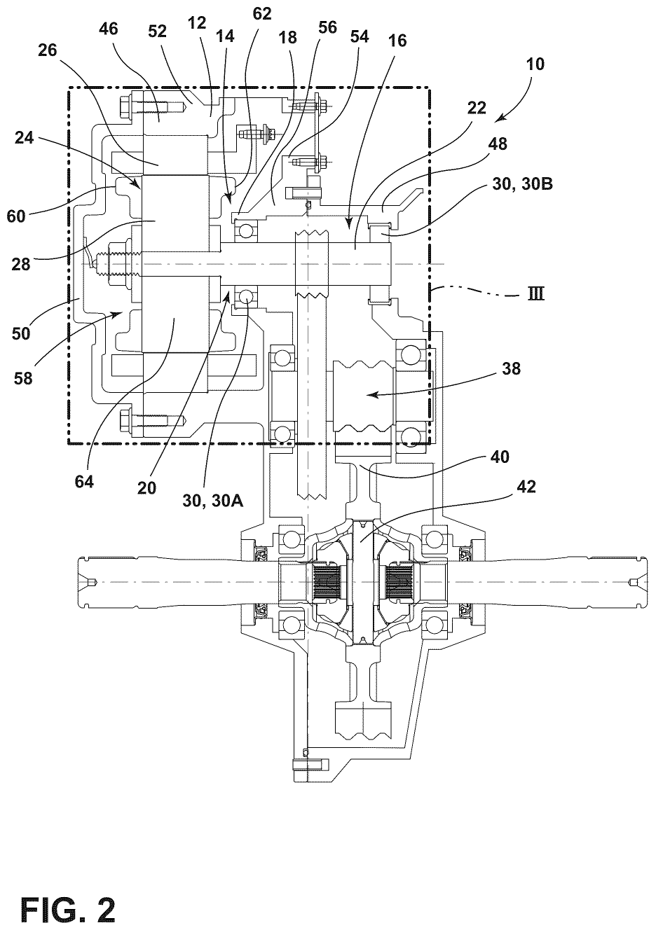

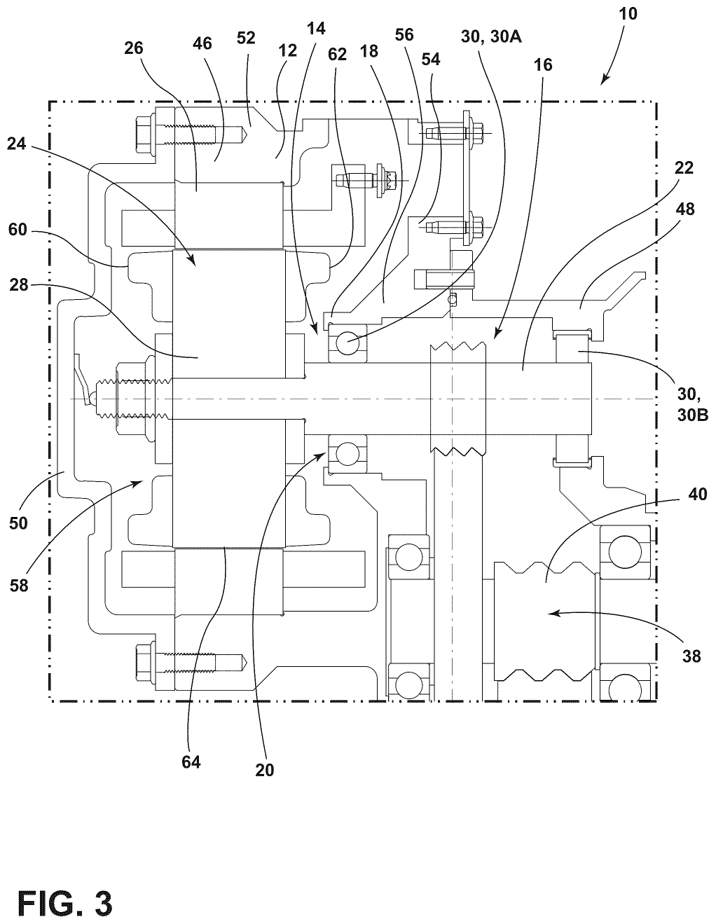

Referring now to FIGS. 2-5, the electric drive unit 10 includes the housing 12. The housing 12 can be an assembly of a plurality of components. For example, in the embodiment illustrated in FIGS. 2 and 3, the housing 12 is a die-cast aluminum housing that is formed of a plurality of components. In the illustrated embodiment, the housing 12 includes a first housing component 46, or left housing 46, a second housing component 48, or right housing 48, and a third housing component 50, or cover 50. The first housing component 46 may include an opening configured for high voltage connections or busbars to extend through. The first housing component 46 may be fixed to the third housing component 50 via, for example, a bolted connection. The third housing component 50 may be of a stamped construction and may be made of steel, in various implementations. The first and second housing components 46, 48 may be fixed to each other. For example, the first housing component 46 may be fixed to the second housing component 48 via a bolted connection and a sealing element.

The first housing component 46 may include a first axially extending section 52, a radially extending section 54, and a second axially extending section 56 that is connected to the first axially extending section 52 via the radially extending section 54. The first axially extending section 52, the radially extending section 54, and the second axially extending section 56 may be of integral construction, in some implementations. The first axially extending section 52 may be located radially outward of the second axially extending section 56. As illustrated in FIG. 2, the plurality of bearings 30 includes a first bearing 30A and a second bearing 30B. The first bearing 30A is received within and contacts an inner surface of the first housing component 46, and the second bearing 30B is received within and contacts an inner surface of the second housing component 48. In this way, the first and second bearings 30A, 30B (each of which is configured to support and facilitate rotation of the rotor shaft 22) are disposed within the gearbox region 16 of the housing 12 to receive lubrication from existing lubrication circuits provided therein, whereby the gearbox region 16 is bounded and defined by both the first and second housing components 46, 48. A variety of types of housings 12 are contemplated.

Referring still to FIGS. 2-5, the housing 12 of the electric drive unit 10 defines an interior region 58. The interior region 58 can include the motor housing region 14 and the gearbox region 16. As illustrated in FIGS. 2 and 3, the housing 12 includes the bearing shield 18. The bearing shield 18 extends between the motor housing region 14 and the gearbox region 16 defined by the housing 12 and defines the aperture 20. As described further herein, the rotor shaft 22 of the electric drive unit 10 may be configured to extend through the aperture 20 from the motor housing region 14 into the gearbox region 16. Further, the bearing shield 18 may be configured to house a bearing 30 that supports and facilitates rotation of the rotor shaft 22.

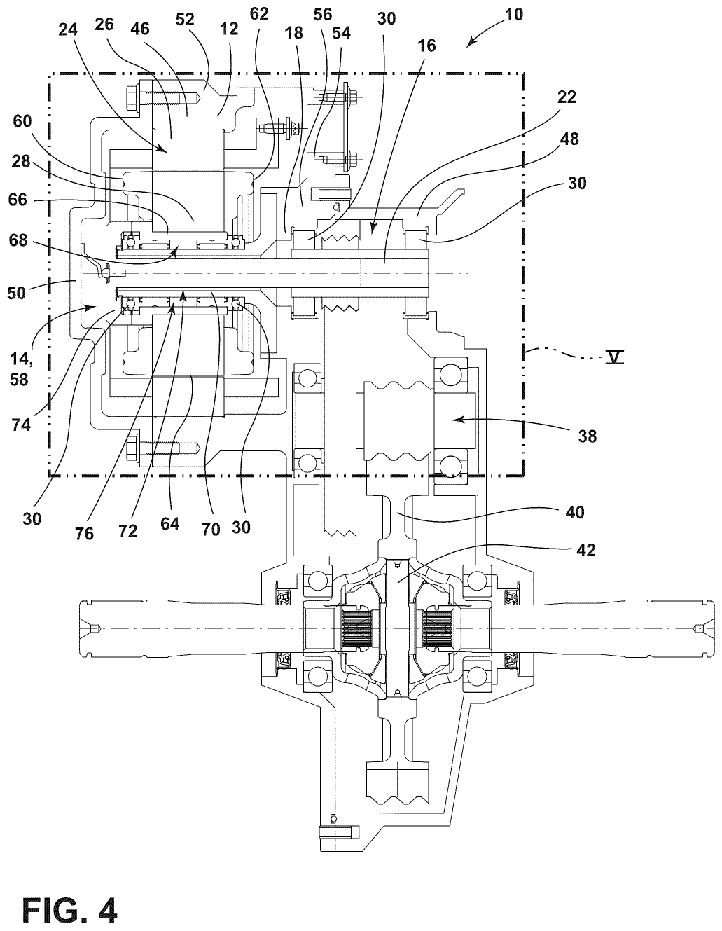

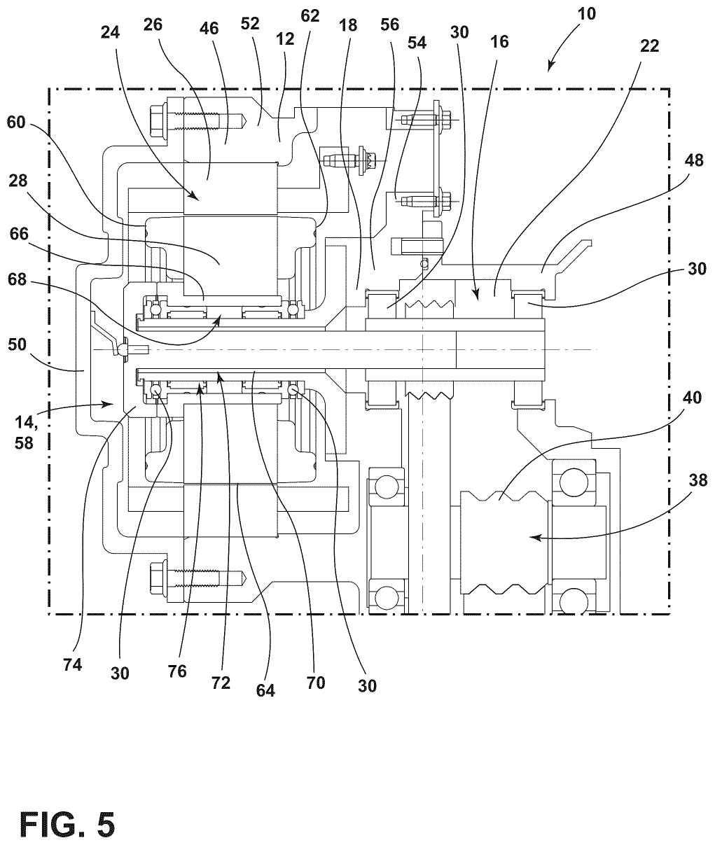

Referring now to FIGS. 2-5, the electric drive unit 10 includes the motor 24. The motor 24 is disposed within the motor housing region 14 and includes the stator 26 and the rotor 28. The rotor 28 extends axially in a first axial direction from a first axial end 60 of the rotor 28 to a second axial end 62 of the rotor 28 that is opposite the first axial end 60. As illustrated in FIGS. 2-5, the rotor 28 includes an axial midpoint 64 that is positioned axially equidistant from the first and second axial ends 60, 62 of the rotor 28. In the embodiment illustrated in FIGS. 2 and 3, the rotor 28 is arranged on the rotor shaft 22, such that operation of the motor 24 drives rotation of the rotor shaft 22. In the embodiment illustrated in FIGS. 4 and 5, the rotor 28 is arranged on a rotor carrier 66 of the electric drive unit 10, such that operation of the motor 24 drives rotation of the rotor carrier 66. The rotor carrier 66 includes an interior surface that defines a rotor carrier hollow 68 and an exterior surface opposite the interior surface, as illustrated in FIGS. 4 and 5. The rotor carrier hollow 68 has openings at opposite axial ends of the rotor carrier hollow 68, such that various components (e.g., spindle 70, rotor shaft 22, etc.) of the electric drive unit 10 are operable to extend axially through the rotor carrier hollow 68.

Referring still to FIGS. 2-5, the electric drive unit 10 includes the rotor shaft 22. The rotor shaft 22 extends through the aperture 20 defined by the bearing shield 18 from the motor housing region 14 into the gearbox region 16. It is contemplated that the rotor shaft 22 may be an assembly of a plurality of coaxial rotor shaft components, in some implementations. In the embodiment illustrated in FIGS. 2 and 3, the rotor 28 is arranged on the rotor shaft 22, such that operation of the motor 24 drives rotation of the rotor shaft 22. In the embodiment illustrated in FIGS. 4 and 5, the rotor shaft 22 is coupled to the rotor carrier 66 upon which the rotor 28 is arranged, such that operation of the motor 24 drives rotation of the rotor carrier 66 and rotation of the rotor shaft 22 at a common rate of rotation. As illustrated in FIGS. 4 and 5, the rotor shaft 22 extends axially through the rotor carrier hollow 68. In various embodiments, rotation of the rotor shaft 22 drives rotation of a plurality of gears of the gearset 40 and operation of the differential 42 within the gearbox region 16 defined by the housing 12. Rotation of gears within the gearbox region 16 may cause splashing of a fluid, such as oil, within the gearbox region 16, which may lubricate various components of the electric drive unit 10, such as bearings, as described further herein.

Referring now to FIGS. 4 and 5, in some implementations, a spindle 70 extends within the interior region 58 defined by the housing 12. As illustrated in FIGS. 4 and 5, the spindle 70 extends within the motor housing region 14 of the housing 12 within the rotor carrier hollow 68 defined by the interior surface of the rotor carrier 66. In various embodiments, the spindle 70 is coupled with the housing 12 and extends outward therefrom into the interior region 58 defined by the housing 12. In some implementations, the spindle 70 is integrally coupled with the housing 12 (e.g., as a machined portion of the housing 12). In some implementations, the spindle 70 is fastened to the housing 12 via bolts and/or a variety of other fasteners.

The spindle 70 includes an interior surface that defines a spindle hollow 72 and an exterior surface opposite the interior surface. The spindle hollow 72 has openings at opposite axial ends of the spindle hollow 72, such that various components of the electric drive unit 10 are operable to extend axially through the spindle hollow 72. In the exemplary embodiment illustrated in FIGS. 4 and 5, the rotor shaft 22 extends axially through the spindle hollow 72. In the illustrated embodiment, the rotor shaft 22 includes a flange 74 that extends radially outboard proximate an axial end of the rotor shaft that is within the motor housing region 14 of the housing 12. The flange 74 is coupled to the rotor carrier 66. In an exemplary embodiment, wherein the electric drive unit 10 is a coaxial drive unit, the spindle hollow 72 may receive the rotor shaft 22 and an output shaft (not shown) that extends within the rotor shaft 22 therethrough.

As illustrated in FIGS. 4 and 5, the spindle 70 extends axially within the rotor carrier hollow 68, such that the interior surface of the rotor carrier 66 and the exterior surface of the spindle 70 at least partially define a fluid flow passage 76 for fluid to flow. The fluid that flows in the fluid flow passage 76 may be configured to absorb heat from the motor 24 that is transferred from the motor 24 to the fluid through the rotor carrier 66 and lubricate various components of the electric drive unit 10, such as the bearings 30, as described further herein.

Referring now to FIGS. 2-5, the electric drive unit 10 includes a plurality of bearings 30. The plurality of bearings 30 may be configured to support and facilitate rotation of a plurality of components of the electric drive unit 10 in operation of the electric drive unit 10. For example, the plurality of bearings 30 may be operable to support and facilitate rotation of the rotor shaft 22 and/or the rotor carrier 66, as described further herein. The bearings 30 can be configured to support the rotor carrier 66 and/or the rotor shaft 22 axially and/or radially. Various types of bearings 30 may be utilized, in various embodiments (e.g., needle roller bearings, cylindrical roller bearings with a thrust washer, deep groove ball bearings, tapered roller bearings, angular contact bearings, etc.). Further, in various embodiments, the bearings 30 can be unsealed bearings 30, as described further herein.

Referring now to FIGS. 2 and 3, an exemplary embodiment of the electric drive unit 10 is illustrated. In the exemplary embodiment, the electric drive unit 10 includes the housing 12 that defines the motor housing region 14 and the gearbox region 16. The housing 12 includes the bearing shield 18 that extends between the motor housing region 14 and the gearbox region 16. The rotor shaft 22 extends axially through the aperture 20 defined by the bearing shield 18 from the motor housing region 14 into the gearbox region 16. The motor 24 is disposed within the motor housing region 14, and the rotor 28 of the motor 24 is arranged on the rotor shaft 22. A plurality of bearings 30 are operably coupled with the rotor shaft 22. The plurality of bearings 30 are configured to support and facilitate rotation of the rotor shaft 22 and the plurality of bearings 30 includes every bearing 30 of the electric drive unit 10 that is operably coupled with the rotor shaft 22 and configured to support and facilitate rotation of the rotor shaft 22. For example, as illustrated in FIGS. 2 and 3, the plurality of bearings 30 includes a first bearing 30A and a second bearing 30B, and the first and second bearings 30A, 30B constitute every bearing 30 of the electric drive unit 10 that is operably coupled with the rotor shaft 22 and configured to support and facilitate rotation of the rotor shaft 22. As illustrated in FIGS. 2 and 3, the first and second bearings 30A, 30B are housed within the housing 12. The first bearing 30A extends radially between the bearing shield 18 and the rotor shaft 22. In the exemplary embodiment, the first bearing 30A is an unsealed bearing, such as an unsealed roller bearing. The second bearing 30B is axially offset from the first bearing 30A, such that the second bearing 30B is further than the first bearing 30A from the aperture 20 defined by the bearing shield 18. As illustrated in FIGS. 2 and 3, each of the plurality of bearings 30 is disposed outside of the motor housing region 14 defined by the housing 12, and each of the plurality of bearings 30 is disposed within the gearbox region 16 defined by the housing 12.

Referring still to the embodiment of the electric drive unit 10 illustrated in FIGS. 2 and 3, each bearing 30 of the plurality of bearings 30 that is configured to support and facilitate rotation of the rotor shaft 22 is axially offset from the axial midpoint 64 of the rotor 28 of the motor 24 in the first axial direction. Further, at least a portion of each of the plurality of bearings 30 is axially offset from the second axial end 62 of the rotor 28 in the first axial direction. In various embodiments, the gearset 40 disposed within the gearbox region 16 is operable to splash fluid disposed within the gearbox region 16 to lubricate at least one of the plurality of bearings 30. Further, the motor housing region 14 and the gearbox region 16 may be sealed from each other (e.g., via a seal), such that fluid is prevented from entering the motor housing region 14 from the gearbox region 16. As illustrated in FIGS. 2 and 3, the rotor shaft 22 being supported by the plurality of bearings 30, each of which is within the gearbox region 16 and/or outside of the motor housing region 14, results in the rotor shaft 22 extending into the motor housing region 14 in a cantilevered manner from the gearbox region 16.

Referring now to FIGS. 4 and 5, an exemplary embodiment of the electric drive unit 10 is illustrated. In the illustrated embodiment, the housing 12 defines the interior region 58. The motor 24 is disposed within the interior region 58 and is operable to drive rotation of the rotor carrier 66. The rotor carrier 66 defines the rotor carrier hollow 68 that is axially aligned with and radially inboard of the rotor 28 of the motor 24. The spindle 70 is coupled to the housing 12 and extends within the rotor carrier hollow 68. The spindle 70 defines the spindle hollow 72. The rotor shaft 22 extends through the spindle hollow 72 and is coupled to the rotor carrier 66, such that the rotor shaft 22 and the rotor carrier 66 are configured to rotate at a common rate of rotation. At least one bearing 30 extends radially between the rotor carrier 66 and the spindle 70. The at least one bearing 30 is configured to support and facilitate rotation of the rotor carrier 66 relative to the spindle 70. As illustrated in FIGS. 4 and 5, the at least one bearing 30 comprises a plurality of bearings 30, and the plurality of bearings 30 includes each bearing 30 that supports and facilitates rotation of the rotor carrier 66. At least a portion of each bearing 30 of the plurality of bearings 30 is positioned axially between the first axial end 60 of the rotor 28 and the second axial end 62 of the rotor 28. The rotor carrier 66 and the spindle 70 at least partially define the fluid flow passage 76. Fluid that flows within the fluid flow passage 76 in the void that is radially between the exterior surface of the spindle 70 opposite the spindle hollow 72 and the interior surface of the rotor carrier 66 that defines the rotor carrier hollow 68 is configured to absorb heat from the motor 24 that is transferred through the rotor carrier 66 and lubricate the plurality of bearings 30 that support and facilitate rotation of the rotor carrier 66. In the exemplary embodiment, the fluid flow passage 76 is sealed from the motor 24, such that the fluid within the fluid flow passage 76 does not flow to the motor 24 of the electric drive unit 10. As illustrated in FIGS. 4 and 5, the electric drive unit 10 includes a second plurality of bearings 30 that are disposed within the gearbox region 16 and support and facilitate rotation of the rotor shaft 22.

The present disclosure may provide a variety of advantages. First, each bearing 30 that supports and facilitates rotation of the rotor shaft 22 being disposed within the gearbox region 16 rather than the motor housing region 14 defined by the housing 12 allows for the bearings 30 to be lubricated by fluid within the gearbox region 16 and eliminates the need for fluid within the motor housing region 14. As such, a sealed bearing 30 within the motor housing region 14 is unnecessary, and the electric motor 24 may run in dry condition. Second, the bearings 30 that extend radially between the spindle 70 and the rotor carrier 66 being disposed at positions that are axially between the first axial end 60 of the rotor 28 and the second axial end 62 of the rotor 28 may reduce the axial footprint of the electric drive unit 10.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 electric drive unit
12 housing
14 motor housing region
16 gearbox region
18 bearing shield
20 aperture
22 rotor shaft
24 motor
26 stator
28 rotor
30 bearings
30A first bearing
30B second bearing
32 vehicle
34 electric axle assembly
36 wheel
38 transmission
40 gearset
42 differential
44 half shafts
46 first housing component/left housing
48 second housing component/right housing
50 third housing component/cover
52 first axially extending section
54 radially extending section
56 second axially extending section
58 interior region
60 first axial end
62 second axial end
64 axial midpoint
66 rotor carrier
68 rotor carrier hollow
70 spindle
72 spindle hollow
74 flange
76 fluid flow passage

What is claimed is:

1. An electric drive unit, comprising:
a housing that defines a motor housing region and a gearbox region, the housing having a bearing shield that extends between the motor housing region and the gearbox region and defines an aperture;
a rotor shaft that extends axially through the aperture from the motor housing region into the gearbox region;
a motor disposed within the motor housing region and including a stator and a rotor arranged on the rotor shaft; and
a plurality of bearings operably coupled with the rotor shaft and configured to support and facilitate rotation of the rotor shaft, wherein the plurality of bearings includes every bearing of the electric drive unit that is operably coupled with the rotor shaft and configured to support and facilitate rotation of the rotor shaft, and wherein at least one of (1) each of the plurality of bearings is disposed outside of the motor housing region and (2) each of the plurality of bearings is disposed within the gearbox region.

2. The electric drive unit of claim 1, wherein the plurality of bearings comprises:
a first bearing that extends radially between the bearing shield and the rotor shaft.

3. The electric drive unit of claim 2, wherein the first bearing is an unsealed bearing.

4. The electric drive unit of claim 2, wherein the plurality of bearings further comprises:
a second bearing axially offset from the first bearing, such that the second bearing is further than the first bearing from the aperture defined by the bearing shield.

5. The electric drive unit of claim 1, wherein the rotor shaft is an assembly of a plurality of coaxial rotor shaft components.

6. The electric drive unit of claim 1, wherein each of the plurality of bearings is disposed outside of the motor housing region.

7. The electric drive unit of claim 1, wherein each of the plurality of bearings is disposed within the gearbox region.

8. The electric drive unit of claim 1, wherein the electric drive unit is a portion of an electric axle assembly of a vehicle.

9. An electric axle assembly for a vehicle, comprising:
a housing that defines an interior region;
a motor disposed within the interior region and having a stator and a rotor that extends in a first axial direction from a first axial end to a second axial end opposite the first axial end and includes an axial midpoint positioned axially equidistant from the first and second axial ends of the rotor;
a rotor shaft operably coupled with the rotor, such that operation of the motor drives rotation of the rotor shaft; and
a plurality of bearings operably coupled with the rotor shaft and configured to support and facilitate rotation of the rotor shaft, wherein the plurality of bearings includes every bearing of the electric axle assembly that is operably coupled with the rotor shaft and configured to support and facilitate rotation of the rotor shaft, and wherein each of the plurality of bearings is axially offset from the axial midpoint of the rotor in the first axial direction.

10. The electric axle assembly of claim 9, wherein at least a portion of each of the plurality of bearings is axially offset from the second axial end of the rotor in the first axial direction.

11. The electric axle assembly of claim 9, wherein the interior region includes a motor housing region that houses the motor, and a gearbox region, and wherein the rotor shaft extends from the motor housing region into the gearbox region.

12. The electric axle assembly of claim 11, wherein each of the plurality of bearings is positioned within the gearbox region.

13. The electric axle assembly of claim 12, wherein each of the plurality of bearings is positioned outside of the motor housing region.

14. The electric axle assembly of claim 13, further comprising:
a gearset disposed within the gearbox region and operable to splash fluid disposed within the gearbox region to lubricate at least one of the plurality of bearings.

15. The electric axle assembly of claim 14, wherein the motor housing region and the gearbox region are sealed from each other, such that fluid is prevented from entering the motor housing region from the gearbox region.

16. The electric axle assembly of claim 9, wherein the rotor shaft is an assembly of a plurality of coaxial rotor shaft components.

17. An electric axle assembly for a vehicle, comprising:
a housing that defines an interior region;
a motor having a stator and a rotor and being disposed within the interior region defined by the housing, wherein the motor is operable to drive rotation of a rotor carrier that defines a rotor carrier hollow and that is axially aligned with and radially inboard of the rotor;
a spindle that defines a spindle hollow, the spindle being coupled to the housing and extending within the rotor carrier hollow;
a rotor shaft that extends through the spindle hollow and that is coupled to the rotor carrier, such that the rotor shaft and rotor carrier are configured to rotate together at a common rate of rotation; and
at least one bearing that extends radially between the rotor carrier and the spindle, wherein the at least one bearing is configured to support and facilitate rotation of the rotor carrier relative to the spindle.

18. The electric axle assembly of claim 17, wherein the rotor extends axially from a first axial end of the rotor to a second axial end of the rotor opposite the first axial end, wherein the at least one bearing comprises a plurality of bearings that includes each bearing that supports and facilitates rotation of the rotor carrier, and further wherein at least a portion of each bearing of the plurality of bearings is positioned axially between the first axial end of the rotor and the second axial end of the rotor.

19. The electric axle assembly of claim 17, wherein the rotor carrier and the spindle at least partially define a fluid flow passage for fluid that is configured to absorb heat from the motor that is transferred through the rotor carrier and lubricate the at least one bearing.

20. The electric axle assembly of claim 19, wherein the fluid flow passage is sealed, such that the fluid does not flow to the motor.
